(19) United States
(12) Patent Application Publication
(10) Pub. No.: US 2017/0044345 A1
(43) Pub. Date: Feb. 16, 2017

(54) LIGHTWEIGHT STYRENE POLYMER COMPOSITIONS

(71) Applicant: INEOS STYROLUTION GROUP GMBH, Frankfurt (DE)

(72) Inventors: Norbert NIESSNER, Friedelsheim (DE); Mohammed ABBOUD, Riverside, IL (US); Andrew CHUNG, Naperville, IL (US)

(21) Appl. No.: 15/305,702

(22) PCT Filed: Apr. 24, 2015
(86) PCT No.: PCT/EP2015/058881

§ 371 Date: Oct. 21, 2016

(30) Foreign Application Priority Data
Apr. 25, 2014 (EP) 14165955.7

(51) Int. Cl. C08J 9/32; B29C 45/00; C08J 9/10

(52) U.S. Cl. CPC C08J 9/32; C08J 9/103; B29C 45/0001; B29C 45/0053; C08J 2203/04; C08J 2355/02; B29K 2101/12

(57) ABSTRACT

A thermoplastic molding composition is provided for use in automotive applications comprising: A) 40 to 88% by weight of an ABS and/or ASA resin, B) 5 to 30% by weight of hollow glass microspheres, C) 0.1 to 2.5% by weight of a chemical foaming agent, D) optionally 1 to 5% by weight of a compatibilizing agent, E) optionally 0 to 20% by weight of an impact modifier, and F) optionally 0.1 to 3% by weight of a plastic processing aid, wherein the sum of components A) to F) totals 100% by weight.

The present invention deals with lightweight thermoplastic molding compositions comprising styrene polymers, in particular ABS (acrylonitrile-butadiene-styrene) resins and/or ASA (acrylonitrile-styrene-acrylate) resins, a process for their preparation, shaped articles comprising said molding composition, and the use of the molding composition for automotive applications.

The need for overall vehicle weight reduction to achieve future Corporate Average Fuel Economy (CAFÉ) regulations is well known. Up until now, most vehicle weight reduction was achieved through substitution of metals with polymers; however the future CAFÉ standards require further reducing the vehicle weight.

Styrenic copolymers are the material of choice for both interior and exterior automotive applications. Thus, it has been an object of the invention to provide light-weight thermoplastic molding compositions based on styrenic polymers.

CN-A 102746606 discloses a modified ABS composition, filled with 5-30 wt.-% hollow glass beads which have a particle size between 10 to several hundred μm, in order to provide a low cost ABS material having good mechanical and flow properties. The material can be used for instruments, household applications, entertainment products and construction industry. Light-weight or automotive applications are not mentioned.

It was surprisingly found that the problem mentioned above can be solved by the thermoplastic molding compositions according to the claims.

One aspect of the invention is a thermoplastic molding composition comprising (or consisting of) as components A) to F),
A) 40 to 88% by weight of ABS and/or ASA resin, preferably ABS resin,
B) 5 to 30% by weight of hollow glass microspheres,
C) 0.1 to 2.5% by weight of chemical foaming agent,
D) optionally, 1 to 5% by weight of compatibilizing agent,
E) optionally, 0 to 20% by weight of an impact modifier, and
F) optionally, 0.1 to 3% by weight of a plastic processing aid component,
wherein the sum of components A) to F) totals 100% by weight.

According to one embodiment of the invention relates to a thermoplastic molding composition comprising
(or consisting of) as components A) to F),
A) 50 to 88% by weight of an ABS and/or an ASA resin,
B) 5 to 30% by weight of hollow glass microspheres,
C) 0.1 to 2.5% by weight of a chemical foaming agent,
D) 1 to 5% by weight of a compatibilizing agent,
E) 0.1 to 20%, preferably 5 to 20% by weight of an impact modifier, and
F) optionally 0.1 to 3% by weight of a plastic processing aid component,
wherein the sum of components A) to F) totals 100% by weight.

Preferably the thermoplastic molding composition comprises
(or consists of) components A) to F), in the following amounts:
A) 50 to 75% by weight of an ABS and/or ASA resin, preferably an ABS resin,
B) 10 to 25%, preferably 12 to 22% by weight, of hollow glass microspheres,
C) 0.1 to 2.5% by weight of a chemical foaming agent,
D) optionally 1 to 5% by weight of a compatibilizing agent,
E) optionally 0 to 20% by weight of an impact modifier, and
F) optionally 0.1 to 3% by weight of a plastic processing aid,
wherein the sum of components A) to F) totals 100% by weight.

According to one further preferred embodiment of the invention the thermoplastic molding composition comprises (or consists of) components A) to F), in the following amounts:
A) 50 to 75% by weight of an ABS and/or ASA resin, preferably an ABS resin,
B) 10 to 25%, preferably 12 to 22% by weight, of hollow glass microspheres,
C) 0.1 to 2.5% by weight of a chemical foaming agent,
D) 1 to 5% by weight of a compatibilizing agent,
E) 0.1 to 20%, preferably 5 to 20% by weight of an impact modifier, and
F) optionally 0.1 to 3% by weight of a plastic processing aid,
wherein the sum of components A) to F) totals 100% by weight.

According to one further preferred embodiment of the invention the thermoplastic molding composition comprises (or consists of) components A) to F), in the following amounts:
A) 52 to 75% by weight of an ABS and/or ASA resin, preferably an ABS resin,
B) 12 to 22% by weight of hollow glass microspheres,
C) 0.5 to 2.0% by weight of a chemical foaming agent,
D) 3 to 4% by weight of a compatibilizing agent,
E) 1 to 20%, preferably 5 to 20% by weight of an impact modifier, and
F) optionally 0.1 to 3% by weight of a plastic processing aid,
wherein the sum of components A) to F) totals 100% by weight.

More preferably the thermoplastic molding composition comprises
(or consists of) components A) to F), in the following amounts:
A) 50 to 70% by weight of an ABS and/or ASA resin, preferably an ABS resin,
B) 10 to 25%, preferably 12 to 22% by weight, of hollow glass microspheres,
C) 0.1 to 2.5% by weight of a chemical foaming agent,
D) 1 to 5% by weight of a compatibilizing agent,
E) 5 to 20% by weight of an impact modifier, and
F) optionally 0.1 to 3% by weight of a plastic processing aid,
wherein the sum of components A) to F) totals 100% by weight.

According to one further more preferred embodiment of the invention the thermoplastic molding composition comprises (or consists of) components A) to F), in the following amounts:
A) 55 to 70% by weight of an ABS and/or ASA resin, preferably an ABS resin,
B) 12 to 22% by weight of hollow glass microspheres,
C) 0.5 to 2.0% by weight of a chemical foaming agent,
D) 3 to 4% by weight of a compatibilizing agent,
E) 5 to 17% by weight of an impact modifier, and
F) optionally 0.1 to 3% by weight of a plastic processing aid,
wherein the sum of components A) to F) totals 100% by weight.

In particular preferred are inventive thermoplastic molding composition comprising or consisting of components A) to F), in the following amounts:
A) 50 to 60% by weight of an ABS and/or ASA resin, preferably an ABS resin,
B) 12 to 22% by weight of hollow glass microspheres,
C) 0.1 to 2.5% by weight of a chemical foaming agent,
D) 1 to 5% by weight of a compatibilizing agent,
E) 5 to 20% by weight of an impact modifier, and
F) optionally, 0.1 to 3% by weight of a plastic processing aid,
wherein the sum of components A) to F) totals 100% by weight.

Among the afore-mentioned molding compositions, such are in particular preferred wherein the amount of component C) is 0.5 to 2.0 wt.-%.

If in said afore-mentioned molding compositions optional compounds D), E) or F) are present, and/or the amounts of compounds B) to F) are further specified, the amount of component A) is adapted accordingly within the given range, provided that the amounts of components A) to F) add up to 100% by weight.
In the inventive molding compositions comprising (or consisting of) components A) to C) and optional components D), E) and F), the amount of component A) is at least 40%, preferably at least 50%, more preferably at least 55% by weight.

In addition, the molding composition of the invention may contain further additives K, being different from components B) to F), such as plasticizers, waxes, antioxidants, silicone oil, stabilizers, flame-retardants, fibers, mineral fibers, mineral fillers, dyes, pigments and the like.

Said additives K may optionally be present in the inventive polymer composition in low amounts, such as 0.1 to 5 parts by weight, preferably 0.1 to 3 parts by weight, per 100 parts resin of the total of components A) to F).

Furthermore the molding composition as afore-mentioned can optionally comprise other rubber-free thermoplastic polymers L, such as polycarbonates and polyamides.

Said polymers L can be added in amounts of 0.1 to 10 parts by weight, per 100 parts resin of the total of components A) to F). Said polymers L can be added separately to the inventive molding composition or can be used as blend with the ABS or ASA resin of component A.

Preferably the afore-mentioned compositions do not comprise further additives K.

### Component A

Suitable components A are ABS or ASA resins, their mixtures and typical blends of ABS and/or ASA-resin with polycarbonate and/or polyamide which are commonly known to a person skilled in the art and are commercially available. Typical examples of suitable commercially available products are such as
Terluran® GP22; Terluran HI-10; Luran® S 797; Luran S 778T; Luran S 757; Terblend® N NM-21 EF (ABS/PA); Terblend S NM-31 (ASA/PA); Luran S KR2864C (ASA/PC) and Novodur® P2H-AT, all of which are obtainable from Styrolution company (Frankfurt, Germany).

The products Terluran® GP22 and Terluran HI-10, preferably Terluran HI-10, are in particular preferred as component A.

ABS resins alone or their blends with polycarbonate and/or polyamide are preferably used.

ABS (acrylonitrile-butadiene-styrene) resins are commonly known and are commercially available.

Suitable ABS resins A) comprise graft copolymers A1) of a diene-based rubber, in particular a butadiene rubber, upon which a mixture of at least one vinylaromatic monomer, in particular styrene, and acrylonitrile and optionally further monoethylenically unsaturated monomers is grafted.

Said ABS graft copolymers A1) can be used as component A) alone or, preferably, in mixture with a rubber free vinyl copolymer A2), in particular a copolymer of a vinylaromatic monomer and acrylonitrile and optionally an additional monoethylenically unsaturated monomer.

The graft copolymer A1) is usually embedded in a matrix made from the rubber free vinyl copolymer A2).

An ABS resin A) comprising an ABS graft copolymer A1) and a styrene-acrylonitrile (SAN) copolymer A2) is very particular preferred.
Preferred SAN-copolymers A2) comprise generally 18 to 35 wt.-%, preferably 20 to 32 wt.-%, particular preferably 22 to 30 wt.-% acrylonitrile (AN), and 82 to 65 wt.-%, preferably 80 to 68 wt.-%, particular preferably 78 to 70 wt.-% styrene (S), wherein the sum of the amounts of styrene and acrylonitrile totals 100 wt.-%.

Said SAN copolymers A2) are also known and commercially available as for example Luran® VLN; VLP; VLR from Styrolution company.

According to the invention ABS resins A) as herein before and hereinafter described are preferred which comprise from 5 to 80%, preferably from 15 to 60%, particularly preferably from 35 to 55%, most preferably 40 to 50% by weight, based on the total of components A) by weight of a graft polymer Al) and from 20 to 95%, preferably from 40 to 85%, particularly preferably from 45 to 65%, most preferably 50 to 60% by weight by weight of a rubber free vinyl copolymer A2).

In particular preferred is an ABS resin A) comprising, components A1) and A2),
A1) from 5 to 80% by weight of a graft polymer A1) having monomodal or, preferred, bimodal particle size distribution made from, based on A),
a1) from 40 to 90% by weight of an elastomeric particulate graft base a1), obtained by polymerization of, based on a1),
a11) from 70 to 100% by weight of at least one conjugated diene, in particular butadiene,
a12) from 0 to 30% by weight of at least one other monoethylenically unsaturated monomer and
a13) from 0 to 10% by weight of at least one polyfunctional, crosslinking monomer and
a2) from 10 to 60% by weight of a graft a2) made from, based on a2),
a21) from 65 to 95% by weight of at least one vinylaromatic monomer, in particular styrene,
a22) from 5 to 35% by weight of acrylonitrile,
a23) from 0 to 30% by weight of at least one other monoethylenically unsaturated monomer, and
a24) from 0 to 10% by weight of at least one polyfunctional, crosslinking monomer and
A2) from 20 to 95% by weight of a thermoplastic polymer A2) having a viscosity number VN (determined according to DIN 53726 at 25° C., 0.5% by weight in dimethylformamide) of from 50 to 120 ml/g, made from, based on A2),
a21) from 69 to 81% by weight of at least one vinylaromatic monomer, in particular styrene,
a22) from 19 to 31% by weight of acrylonitrile, and
a23) from 0 to 30% by weight of at least one other monoethylenically unsaturated monomer.

Such preferred ABS resins are described in U.S. Pat. No. 6,323,279.

Graft copolymers A1) can be prepared by known polymerization techniques, such as solution or bulk polymerization or emulsion polymerization.
A suitable process for the preparation of graft copolymers A1) by emulsion polymerization is disclosed in detail in U.S. Pat. No. 6,323,279. Furthermore it is referred to U.S. Pat. No. 5,434,218 which discloses a suitable process for the preparation of graft copolymers A1) whose rubber phases are prepared exclusively by solution or bulk polymerization.

The graft polymer A1) can then be mixed with copolymer A2) by usual methods. The mixing apparatuses used are those known to the person skilled in the art. Components A1) and A2) may be mixed, for example, by extruding, kneading or rolling them together.

ASA (acrylonitrile-styrene-acrylate) resins used as component A) are also commonly known and are also commercially available.

Suitable ASA resins A) comprise graft copolymers A3) of an acrylate based rubber, in particular a butyl acrylate rubber, upon which a mixture of at least one vinylaromatic monomer, in particular styrene, and acrylonitrile and optionally further monoethylenically unsaturated monomers is grafted. Said ASA graft copolymers A3) can be used as component A) alone or, preferably, in mixture with a rubber free vinyl copolymer A2) as defined above, in particular a copolymer of a vinylaromatic monomer and acrylonitrile and optionally an additional monoethylenically unsaturated monomer. The graft copolymer A3) is usually embedded in a matrix made from the rubber free vinyl copolymer A2).

An ASA resin A), comprising an ASA graft copolymer A3) and a styrene-acrylonitrile (SAN) copolymer A2) is very particular preferred and is commercially available e.g. from Styrolution company as Luran® S 797; Luran S 778T and Luran S 757.

A preferred ASA graft copolymer A3) is built up from
(a₃) from 30 to 90% by weight, based on (A3), of a graft base with a glass transition temperature (T_{g}) below −10° C. made from
(a₃₁) an at least partially crosslinked acrylate polymer formed from
(a₃₁₁) from 50 to 99.9% by weight, based on (a₃₁), of at least one C₁-C₁₀-alkyl acrylate, in particular n-butylacrylate,
(a₃₁₂) from 0.1 to 5% by weight, based on (a₃₁), of at least one poly-functional crosslinking monomer and
(a₃₁₃) from 0 to 49.9% by weight, based on (a₃₁), of a further monomer which is copolymerizable with (a₁₁₁) selected from the group consisting of the vinyl C₁-C₈-alkyl ethers, butadiene, isoprene, styrene, acrylonitrile and methacrylonitrile, and/or methyl methacrylate
(a₄) from 10 to 70% by weight, based on (A), of a graft with a (T_{g}) above 50° C., grafted onto the graft base and built up from
(a₄₁) from 50 to 95% by weight, based on (a₄), of at least one vinylaromatic monomer, in particular styrene,
(a₄₂) from 5 to 50% by weight, based on (a₄), of at least one polar, copolymerizable comonomer selected from the group consisting of acrylonitrile, methacrylonitrile, C₁-C₄-alkyl (meth)acrylates, maleic anhydride and maleimides, and (meth)acrylamide, and/or vinyl C₁-C₈-alkyl ethers, or a mixture of these, in particular acrylonitrile.

Graft copolymers A3) can be prepared by known polymerization techniques, such as solution or bulk polymerization or emulsion polymerization. Suitable graft copolymers A3) and their preparation is disclosed in for example U.S. Pat. Nos. 5,760,134 and 6,579,937 to which is in particular referred.

### Component B

The hollow glass microspheres or hollow glass beads (GB) used as component B) comprise inorganic materials which are typically used for glasses such as e.g. silica, alumina, zirconia, magnesium oxide, sodium silicate, soda lime, borosilicate etc.

Preferably the hollow glass beads comprise soda lime borosilicate, which is commercially available.

The hollow glass beads are preferably mono-modal having usually a particle size (diameter) in the range from 5 to 50 μm, preferably 15 to 25 μm. Furthermore it is preferred that the glass beads are of the thin wall type having preferably a wall thickness of 0.5-1.5 μm.

The density of the hollow glass beads is preferably in the range of from 0.3 to 0.5 g/cm³ and the isotactic pressure resistance is preferably in range of from 80 to 150 MPa.

### Component C

Chemical foaming agents (CFAs) are known and are used on a wide scale. Such agents can be organic or inorganic compounds and can be categorized as either endothermic or exothermic. All types CFA release gases such (mainly carbon dioxide or nitrogen) upon thermal decomposition. The decomposition temperature depends on the type and the chemical nature of the CFA and is generally in range of from 110 to 340° C.

In particular suitable CFAs are one or more of the components selected from the group consisting of Azodicarbonamide (ADC), 4,4-Oxybis(benzenesulfonyl-hydrazide) (OBSH), P-Toluenesulfonylhydrazide (TSH), P-toluenesulfonylsemi-carbazide (TSS), Dinitrosopentamethlenetetramine, Polyphenyl sulfoxide (PPSO) and 5-phenyltetrazole.

Further suitable chemical foaming agents are those which can eliminate carbon dioxide upon thermal energy and/or pH value change. Such components are preferably one or more selected from the group comprising: Sodium carbonate, Sodium bicarbonate, Magnesium carbonate, Stearic acid, Sodium stearate, Potassium stearate, Magnesium stearate, Zinc carbonate, Citric acid derivatives. Other organic acids and salts of organic acids (e.g. rosin soap and derivatives) can also be used. Also mixtures of the before mentioned products are allowed. In that case, mixtures of citric acid with carbonates (sodium carbonate, sodium hydrogen carbonate, magnesiumcarbonate) are in particular preferred.

Among said CFAs ADC, OBSH, TSH, TSS and Dinitrosopentamethlenetetramine are examples for the exothermic type and Sodium bicarbonate, Zinc carbonate, Citric acid derivatives and 5-phenyltetrazole are examples for the endothermic type.

In particular preferred is Azodicarbonamide (ADC).

Component C) is used in amounts of from 0.1 to 2.5 wt.-%, preferably from 0.5 to 2.0 wt.-%.

### Component D

The molding composition can comprise one or more compatibilizing agent D which improves the bonding of the hollow glass beads to the polymer phase. Preferably the compatibilizing agent D) is comprised in an amount of 2 to 5%, more preferably 3 to 4% by weight.

Preferably the compatibilizer is a low molecular weight functional component with e.g. epoxy-, maleic anhydride or maleic imide functions. Typical examples are styrene-maleic anhydride copolymers, styrene-acrylonitrile-maleic anhydride copolymers, N-Phenyl maleic imide-maleic anhydride copolymers. In particular preferred is a Styrene-Acrylonitrile grafted maleic anhydride (SAN-g-MAH) copolymer.

Suitable (SAN-g-MAH) copolymers are disclosed in U.S. Pat. No. 8,030,393 B2 to which is in particular referred.

### Component E

Suitable impact modifiers E) are preferably block copolymers comprising monomer units of a vinylaromatic monomer, in particular styrene, and a diene, in particular butadiene. Said block copolymers are preferably Styrene-Butadiene Block Copolymers (SBC) which are commercially available e.g. as Styroflex® 2G66 from Styrolution company.

The afore-mentioned impact modifiers E) can be used in amounts from 0 to 20 wt.-%, preferably from 1 to 20, in particular from 1 to 17 wt.-%, more preferably from 5 to 20 wt.-%, in particular from 5 to 17 wt.-%, for example 5 to 15 wt.-%, most preferred from 12 to 17 wt.-%, based on the entire amount of components A) to F). If impact modifier E) is present, its minimum amount is 0.1 wt.-%.

### Component F

Suitable plastic processing aids which can be used as component F) include antioxidant agents and lubricants. Suitable lubricants are such as mineral oil, silicon oil, phthalates, waxes and stearates. In particular preferred is an EthyleneBisStearamide (EBS) wax.

Suitable antioxidants are those commonly used and commercially available for ABS and/or ASA molding compositions, in particular suitable are phenolic and phosphate antioxidants. Phosphate antioxidants are preferred.

### Preparation of Thermoplastic Molding Composition

The preparation of the thermoplastic molding composition follows conventional procedures which are well known in the art. Preferably, the components are extrusion blended or compounded in a high intensity blender such as a twin-screw extruder. A twin screw extruder having high channel depth conveying elements is used to avoid breaking of the hollow glass beads. The high channel depth defined by the OD/ID ratio is preferably 1.5 to 2.0, more preferably approximately 1.75.

A particular suitable extruder has 7 heating zones, usually in zones 1, 2 and 4 to 7 are the high channel depth conveying elements, usually in zone 3 is a kneading section. In zone 1 (feeding zone), the inventive polymer composition, except of components B) and C), is fed and passed through a set of kneading blocks to ensure its complete melting. The glass beads are supplied by a side feed in a zone behind the kneading section, which is usually in one of zones 4 to 6, preferably in zone 4.

A further subject of the invention is a process for the preparation of the thermoplastic molding composition comprising the following steps:
i) Mixing and melting of components A) and optional components D), E), F), K) and L), if present, in the feeding section of a twin-screw extruder having high channel depth conveying elements,
ii) Addition of component B) by a side-feed in a zone of the extruder after the kneading section,
iii) Mixing and injection-molding of the obtained extrudated polymer blend with a chemical foaming agent C).

According to a preferred embodiment of the inventive process in a first (optional) step, a mixture of components A) and optional components D), E), F), K) and L), if present, is prepared and pre-mixed to obtain a uniformly mixed material.

In a second step (step i) of said process, said mixture is added into said twin-screw extruder hopper and the compounding is performed on an extruder machine at a temperature in the range of preferably 200 to 250° C. The hollow glass beads (component B)) are added (step ii) in a zone behind the kneading section, by using a side feeder as to introduce the glass beads to the polymer melt to avoid breakage. The molding composition containing additionally the hollow glass beads can be extruded via a die plate and the water chilled polymer strands are preferably granulated.

Preferably, in a third step, the granulated polymer is (pre-) mixed with a chemical foaming agent in the afore-mentioned amounts. Pre-foaming of the CFA prior to filling the mold has to be avoided. Then the (pre-)mixed composition according to the invention can be injection molded with a common injection molding machine.

The thermoplastic molding composition can be formed into shaped articles by a variety of means such as injection molding, extrusion, compression forming, vacuum forming, blow molding etc. well established in the art.

A further subject of the invention is a shaped article made from the thermoplastic molding composition.

By the combination of applying hollow glass beads and a chemical foaming agent it is possible to achieve a high improved weight reduction in the thermoplastic molding composition according to the invention while the good mechanical properties are maintained. The inventive thermoplastic molding composition can be applied for many industries seeking weight reduction without sacrificing many properties.

A further aspect of the invention is the use of a shaped article made from the inventive thermoplastic molding composition for automotive applications such as interior and exterior applications (e.g. molded in front grilles and all chrome plated components such as grilles, mirrors, pillar garnishes, etc.).

The following examples and claims further detail the present invention:

### EXAMPLES

### Materials:

ABS: Terluran® HI-10 (high impact, medium flow, injection molding and extrusion grade ABS of Styrolution, Frankfurt).

Hollow glass microspheres supplied by the U.S. company 3M (soda lime borosilicate glass beads, density 0. 46 g/cc, particles 16 μm diameter, Isotactic pressure resistance 113 Mpa).

Impact modifier: a SBC Styroflex® 2G66 (S-TPE for extrusion, Styrolution, Frankfurt).

Compatibilizing agent: a Styrene-Acrylonitrile grafted maleic anhydride (SAN-g-MAH) copolymer made according to US Patent 8,030,393 B2 (Styrolution VT2421).

Chemical foaming agent (CFA): an azodicarbonamide supplied as Hydrocerol® CF-40-T by Clariant, Frankfurt.

TABLE 1
Thermoplastic Molding Composition (in % by weight)

| Designation | Examp. 1 | Example 2 | Example 3 |
|---|---|---|---|
| ABS resin | 87 | 69 | 58 |
| Glassbeads (16 μm) | 5 | 14 | 20 |
| Compatibilizer | 2.5 | 4 | 4 |
| Impact modifier | 5 | 12 | 16 |
| CFA | 0.5 | 1 | 2 |
| Total | 100 | 100 | 100 |

### Example 1

Step 1, a mixture of 87% by weight of ABS resin, 2.5% Compatibilizer; 5% impact modifier is prepared and pre-mixed to obtain a uniformly mixed material.

Step 2, the mixture is added into a twin-screw extruder hopper (in feeding zone 1 of the extruder). The compounding was performed on an twin screw extruder machine (manufacturer: Berstorff ZE25 L/D=33D, OD/ID: 1.75) at a temperature of 240° C. and 250 r.p.m. Hollow glass beads are added at 5% by weight using a side feeder (placed after the kneading zone of the extruder) as to introduce the glass beads to the polymer melt to avoid breakage. The polymer composition containing additionally the glass beads was extruded via a die plate and the water chilled polymer strands were granulated.

Step 3, the granulated polymer was pre-mixed with 0.5% by weight of a chemical foaming agent and then the pre-mixed composition was injection molded with a common injection molding machine (LG ID 75EN) at 240° C., 75MT clamp force, 60% injection speed, 55° C. mold temperature, to a 3.2 mm thick specimen used for stress/strain test according to the norm ASTM D638 and to 3.2 mm thickness specimen according to the norm ASTM D256.

### Example 2

Step 1, a mixture of 69% by weight of ABS resin, 4% Compatibilizer; 12% impact modifier is prepared and pre-mixed to obtain a uniformly mixed material.

Step 2, the mixture is added into a twin-screw extruder hopper (in feeding zone 1 of the extruder). The compounding was performed on an twin screw extruder machine (manufacturer: Berstorff ZE25 L/D=33D, OD/ID:1.75) at a temperature of 240° C. and 250 r.p.m. Hollow glass beads are added at 14% by weight using a side feeder (placed after the kneading zone of the extruder) as to introduce the glass beads to the polymer melt to avoid breakage. The polymer composition containing additionally the glass beads was extruded via a die plate and the water chilled polymer strands were granulated.

Step 3, the granulated polymer was pre-mixed with at 1 wt.-% of a chemical foaming agent and then the pre-mixed composition was injection molded with a common injection molding machine (LG ID 75EN) at 240° C., 75MT clamp force, 60% injection speed, 55° C. mold temperature, to a 3.2 mm thick specimen used for stress/strain test according to the norm ASTM D638 and to 3.2 mm thickness specimen according to the norm ASTM D256.

### Example 3

Step 1, a mixture of 58% by weight of ABS resin, 4% compatibilizer; 16% impact modifier is prepared and pre-mixed to obtain a uniformly mixed material.

Step 2, the mixture is added into a twin-screw extruder hopper (in feeding zone 1 of the extruder). The compounding was performed on an twin screw extruder machine (manufacturer: Berstorff ZE25 L/D=33D, OD/ID: 1.75) at a temperature of 240° C. and 250 r.p.m. Hollow glass beads are added at 20% by weight using a side feeder (placed after the kneading zone of the extruder) as to introduce the glass beads to the polymer melt to avoid breakage. The polymer composition containing additionally the glass beads was extruded via a die plate and the water chilled polymer strands were granulated.

Step 3 The granulated polymer was pre-mixed with a chemical foaming agent at 2% and then the pre-mixed composition was injection molded with a common injection molding machine (LG ID 75EN) at 240° C., 75MT clamp force, 60% injection speed, 55° C. mold temperature, to a 3.2 mm thick specimen used for stress/strain test according to the norm ASTM D638 and to 3.2 mm thickness specimen according to the norm ASTM D256 (norm used on date of filing).

### Performance Testing and Evaluation:

Results of testing performed on ABS pellets presented in examples 1 to 3 are listed in the table below:

| Tests | Units | Example 1 | Examp. 2 | Example 3 |
|---|---|---|---|---|
| Charpy—Notched [23° C.] | kJ/m² | 22 | 14 | 11 |
| ISO 179/1eA | | | | |
| Melt Volume Rate 220° C./ | cm³/10 | 15 | 12 | 10 |
| 10 kg ISO 1133* | min | | | |
| Tensile Stress at Yield ISO | Mpa | 43 | 42 | 42 |
| 527-2/1A/1 | | | | |
| Tensile Strain at Yield ISO | % | 4.2 | 4 | 4 |
| 527-2/1A/50 | | | | |
| Tensile Strain at Break ISO | % | 11 | 9 | 8 |
| 527-2/1A/50 | | | | |
| Tensile Modulus ISO | Mpa | 2400 | 2710 | 3080 |
| 527-2/1A/50 | | | | |
| Flexural Modulus ISO178 | Mpa | 2300 | 2630 | 2800 |
| Flexural Strength ISO179 | Mpa | 68 | 67 | 66 |
| Vicat Softening Temperature | ° C. | 95 | 96 | 98 |
| ISO 306/B50 (50N at | | | | |
| 50° C./hr) [40 hr, ASTM] | | | | |
| Heat Deflection Temperature | ° C. | 79 | 82 | 84 |
| at 1.82 Mpa [264 psi] | | | | |
| Unannealled ISO 75-2/Af | | | | |
| Weight Reduction | % | 7 | 16 | 23 |
| Ash Content ASTM D5630 | % | 5.1 | 13.9 | 20 |

*Without CFA

As the results show, by the combination of applying hollow glass beads and a chemical foaming agent, it was possible to achieve a high weight reduction and the best retention of advanced properties, making this concept a very viable option for many industries seeking weight reduction without sacrificing much of mechanical properties.

In general, Charpy and MVR properties showed some deterioration but remained within acceptable ranges. Tensile properties remained similar while Tensile and Flexural modulus showed a significant improvement. Heat performance properties improved as well. PATENT

1-18. (canceled)

19. A thermoplastic molding composition comprising, as components A) to F),
A) 40 to 88% by weight of ABS and/or ASA resin
B) 5 to 30% by weight of hollow glass microspheres,
C) 0.1 to 2.5% by weight of chemical foaming agent,
D) optionally 1 to 5% by weight of compatibilizing agent,
E) optionally 0 to 20% by weight of impact modifier, and
F) optionally 0.1 to 3% by weight of plastic processing aid,
wherein the sum of components A) to F) totals 100% by weight.

20. Thermoplastic molding composition according to claim 19, comprising the components A) to F) in the following amounts:
A) 40 to 88% by weight of an ABS and/or an ASA resin,
B) 5 to 30% by weight of hollow glass microspheres,
C) 0.1 to 2.5% by weight of a chemical foaming agent,
D) 1 to 5% by weight of a compatibilizing agent,
E) 5 to 20% by weight of an impact modifier, and
F) optionally 0.1 to 3% by weight of a plastic processing aid component,
wherein the sum of components A) to F) totals 100% by weight.

21. Thermoplastic molding composition according to claim 19, comprising the components A) to F) in the following amounts:
A) 50 to 88% by weight of an ABS and/or an ASA resin,
B) 5 to 30% by weight of hollow glass microspheres,
C) 0.1 to 2.5% by weight of a chemical foaming agent,
D) 1 to 5% by weight of a compatibilizing agent,
E) 0.1 to 20% by weight of an impact modifier, and
F) optionally 0.1 to 3% by weight of a plastic processing aid component,
wherein the sum of components A) to F) totals 100% by weight.

22. Thermoplastic molding composition according to claim 19, comprising the components A) to F) in the following amounts:
A) 50 to 75% by weight of a ABS and/or ASA resin, preferably ABS resin,
B) 10 to 25% by weight of hollow glass microspheres,
C) 0.1 to 2.5% by weight of a chemical foaming agent,
D) 1 to 5% by weight of a compatibilizing agent,
E) optionally 0 to 20% by weight of an impact modifier, and
F) optionally 0.1 to 3% by weight of a plastic processing aid,
wherein the sum of components A) to F) totals 100% by weight.

23. Thermoplastic molding composition according to claim 19, comprising the components A) to F) in the following amounts:
A) 50 to 75% by weight of an ABS and/or ASA resin, preferably an ABS resin,
B) 10 to 25% by weight of hollow glass microspheres,
C) 0.1 to 2.5% by weight of a chemical foaming agent,
D) 1 to 5% by weight of a compatibilizing agent,
E) 0.1 to 20% by weight of an impact modifier, and
F) optionally 0.1 to 3% by weight of a plastic processing aid,
wherein the sum of components A) to F) totals 100% by weight.

24. Thermoplastic molding composition according to claim 19, comprising components A) to F), in the following amounts:
A) 50 to 70% by weight of an ABS and/or ASA resin, preferably an ABS resin,
B) 10 to 25% by weight of hollow glass microspheres,
C) 0.1 to 2.5% by weight of a chemical foaming agent,
D) 1 to 5% by weight of a compatibilizing agent,
E) 5 to 20% by weight of an impact modifier, and
F) optionally 0.1 to 3% by weight of a plastic processing aid,
wherein the sum of components A) to F) totals 100% by weight.

25. Thermoplastic molding composition according to claim 19, comprising components A) to F), in the following amounts:
A) 55 to 70% by weight of an ABS and/or ASA resin, preferably an ABS resin,
B) 12 to 22% by weight of hollow glass microspheres,
C) 0.5 to 2.0% by weight of a chemical foaming agent,
D) 3 to 4% by weight of a compatibilizing agent,
E) 5 to 17% by weight of an impact modifier, and
F) optionally 0.1 to 3% by weight of a plastic processing aid,
wherein the sum of components A) to F) totals 100% by weight.

26. Thermoplastic molding composition according to claim 19, comprising components A) to F), in the following amounts:
A) 50 to 70% by weight of an ABS and/or ASA resin, preferably an ABS resin,
B) 10 to 25%, preferably 12 to 22% by weight, of hollow glass microspheres,
C) 0.1 to 2.5% by weight of a chemical foaming agent,
D) 1 to 5% by weight of a compatibilizing agent,
E) 5 to 20% by weight of an impact modifier, and
F) 0.1 to 3% by weight of a plastic processing aid,
wherein the sum of components A) to F) totals 100% by weight.

27. A thermoplastic molding composition as claimed in claim 19, wherein component A) is an ABS resin.

28. A thermoplastic molding composition as claimed in claim 27, wherein component A) is an ABS resin A) comprising an ABS graft copolymer A1) and a styrene-acrylonitrile (SAN) copolymer A2).

29. A thermoplastic molding composition as claimed in claim 19, wherein component A) is an ASA resin.

30. A thermoplastic molding composition as claimed in claim 19, wherein the hollow glass microspheres B) are mono-modal having a particle size in the range from 5 to 50 μm, preferably 15 to 25 μm.

31. A thermoplastic molding composition as claimed in claim 19 wherein the chemical foaming agent C) is one or more components selected from the group consisting of: Azodicarbonamide (ADC), 4,4-Oxybis(benzenesulfonyl-hydrazide) (OBSH), P-Toluenesulfonylhydrazide (TSH), P-toluenesulfonylsemi-carbazide (TSS), Dinitrosopentamethlenetetramine, Polyphenyl sulfoxide (PPSO) and 5-phenyltetrazole, Sodium carbonate, Sodium bicarbonate, Magnesium carbonate, Stearic acid, Sodium stearate, Potassium stearate, Magnesium stearate, Zinc carbonate, Citric acid derivatives and other organic acids and their salts.

32. A thermoplastic molding composition as claimed in claim 19 wherein the compatibilizing agent D) is selected from styrene-maleic anhydride copolymers, styrene-acrylonitrile-maleic anhydride copolymers and N-Phenyl maleic imide-maleic anhydride copolymers.

33. A thermoplastic molding composition as claimed in claim 19 wherein the impact modifier E) is a block copolymer comprising monomer units of a vinylaromatic monomer and a diene.

34. A process for the preparation of the thermoplastic molding composition according to claim 19 comprising the following steps:
i) Mixing and melting of components A) and optional components D), E), F), K) and L), if present, in the feeding section of a twin-screw extruder having high channel depth conveying elements;
ii) Addition of component B) by a side-feed in a zone of the extruder after the kneading section;
iii) Mixing and injection-molding of the obtained extruded polymer blend with a chemical foaming agent C).

35. A shaped article comprising the thermoplastic molding composition according to claim 19.

36. A method of using the shaped article according to claim 35 for automotive applications.
